(19) United States
(12) Patent Application Publication
(10) Pub. No.: US 2026/0266664 A1
(43) Pub. Date: Sep. 10, 2026

(54) SENSOR ARRANGEMENT

(71) Applicant: TDK Electronics AG, Muenchen (DE)

(72) Inventors: Yeseul Oh, Berlin (DE); Daniel Gille, Berlin (DE); Steffen Mehlig; Felix Krüger, Berlin (DE)

(21) Appl. No.: 19/472,089

(22) PCT Filed: Apr. 12, 2024
(86) PCT No.: PCT/EP2024/059931

§ 371 Date: Oct. 2, 2025

(30) Foreign Application Priority Data
Apr. 12, 2023 (DE) 10 2023 109 189.1

(51) Int. Cl. G01K 1/143; G01K 1/08; G01K 1/14; G01K 7/22

(52) U.S. Cl. CPC G01K 1/143; G01K 1/08; G01K 1/146; G01K 7/22

(57) ABSTRACT

In an embodiment a sensor arrangement includes at least one sensor element, a ceramic housing, wherein the sensor element is at least partially arranged in the ceramic housing, a basic body at least partially surrounding the ceramic housing, an outer housing connected to the basic body, wherein the outer housing at least partially envelops the basic body and the ceramic housing and at least one mounting element configured for mounting the sensor arrangement to a target application, wherein the ceramic housing is configured to be in direct mechanical contact with a surface, and wherein the sensor arrangement is configured to measure a temperature of the surface.

### CROSS-REFERENCE TO RELATED APPLICATIONS

This patent application is a national phase filing under section 371 of PCT/EP2024/059931, filed Apr. 12, 2024, which claims the priority of German patent application no. 102023109189.1, filed Apr. 12, 2023, each of which is incorporated herein by reference in its entirety.

### TECHNICAL FIELD

The present invention relates to a sensor arrangement for measuring a temperature of a surface. Moreover, the present invention relates to a use of the sensor arrangement.

### BACKGROUND

The current trend in e-mobility demands electronic components to have High Voltage (HV) strength. High Voltage insulation can be secured by either longer creepage, clearance distance between the conductors or by sealing the conductor with solid insulation material.

However, this causes sensor design to be large and long in order to meet HV requirements or to have slower response time due to thick insulation material hindering heat transfer.

### SUMMARY

Embodiments provide a sensor arrangement which solves the above-mentioned problems.

According to a first embodiment of the present disclosure, a sensor arrangement is described. The sensor arrangement is configured for measuring a temperature of a surface. The sensor arrangement comprises a temperature sensor arrangement. An operating temperature range of the sensor arrangement may be −40° C. and 180° C., short term up to 200° C.

The sensor arrangement is adapted to be used in High Voltage applications, e.g. on a HV bus bar. The sensor arrangement is specifically adapted to be used in automotive applications, in particular in e-mobility applications.

The sensor arrangement comprises at least one sensor element, preferably exactly one sensor element. The sensor element may comprise a NTC (Negative Temperature Coefficient) thermistor. In particular, the sensor element may comprise a glass NTC thermistor.

The sensor arrangement further comprises a ceramic housing. The term “ceramic housing” is to be understood that a material of the ceramic housing comprises ceramics. The sensor element is at least partly arranged in an interior/inner area of the ceramic housing. The sensor element is firmly fixed in the interior of the ceramic housing, e.g. by a potting material.

The sensor arrangement further comprises a basic body. The ceramic housing is connected to the basic body. The ceramic housing may be clamped into the basic body. The basic body is adapted and arranged to at least partially surround the ceramic housing. For example, a top surface of the ceramic housing and at least a part of side surfaces and of a bottom surface of the ceramic housing may be surrounded by the basic body. Preferably, the basic body comprises plastic. The basic body may be an insulating component of the sensor arrangement.

The sensor arrangement further comprises an outer housing. The outer housing may constitute an outer shell of the sensor arrangement. Preferably, the outer housing comprises plastic. The outer housing may be an insulating component (i.e. a further insulating component) of the sensor arrangement.

It is to be understood that the outer housing and the basic body are different/independent components of the sensor arrangement each fulfilling very specific functions, e.g. an insulating function. The outer housing is connected, preferably non-releasable connected, to the basic body. The outer housing at least partially envelops the basic body and the ceramic housing. The basic body, the ceramic housing and, thus, the sensor element, may be at least partly overmoulded by the outer housing. This means that the sensor arrangement may be an overmoulded component, i.e. it may be overmoulded at least partly by a material of the outer housing. Thus, a very stable and compact sensor arrangement is provided.

The sensor arrangement further comprises at least one mounting element. The mounting element comprises metal. The mounting element is adapted and arranged for mounting the sensor arrangement to a target application (i.e. an application in which the sensor arrangement shall be used), e.g. a HV application.

The mounting element is adapted and arranged to secure a push down force to the surface the temperature of which is to be measured. In other words, the mounting element pushes the sensor arrangement with a defined force onto the surface. Moreover, the mounting element is adapted to provide for a mechanical strength at a mounting position so that the sensor arrangement can withstand vibration required e.g. for a gear box (highest acceleration may be 10.5 g). Thus, a very robust and reliable sensor arrangement is provided.

The mounting element may be designed for releasable mounting the sensor arrangement to the target application. In other words, the mounting element may ensure that the sensor arrangement can be removed from one target application and can be moved to and integrated in a further target application. Accordingly, the sensor arrangement is very flexibly applicable.

The sensor arrangement is designed so that the ceramic housing has an open/exposed surface. In particular, the components of the sensor arrangement interrelate with one another and the ceramic housing is specifically designed so that a surface of the ceramic housing is exposed.

This means that the ceramic housing comprises a surface that is in direct mechanical contact with the surface the temperature of which is to be measured. In other words, the ceramic housing at least partly rests directly on the surface the temperature of which is to be measured, in particular on a measurement point of that surface. In this way, the sensor arrangement can measure the temperature from the surface directly fast and fully insulated. Consequently, the sensor arrangement comprises a very fast response time: t63<10 s (on surface).

The sensor arrangement can be integrated within the monitored application for better thermal contact to the HV surface, also enabling less thermal influence by surroundings.

According to one embodiment, the ceramic housing comprises a sensing area. The sensing area is to be understood as an area of the ceramic housing through which the surface temperature to be measured is transmitted directly to the sensor element. The sensor element may be located in direct proximity to the sensing area. The sensing area may be arranged at a bottom surface of the ceramic housing. The sensing area may constitute a part of the bottom surface of the ceramic housing. The bottom surface may be that surface of the ceramic housing that faces the surface the temperature of which is to be measured once the sensor arrangement is mounted to the target application.

The sensing area at least partially protrudes from the outer housing. This means, the outer housing completely surrounds the basic body and the ceramic housing except for the sensing area. Thus, the sensing area can be brought into direct mechanical contact with the surface when the sensor arrangement is mounted to the target application. In this way, a very efficient sensor arrangement comprising a fast response time is provided.

According to one embodiment, the basic body and the outer housing constitute a double or reinforced HV insulation of the sensor arrangement. This means that instead of only one insulating housing component, the sensor arrangement comprises two separate components (basic body and outer housing) fur ensuring a sufficient HV resistance.

Preferably, the sensor arrangement comprises a High Voltage resistance≤4300 V for DC (Direct Current). In this way, the sensor arrangement is especially suited for a use in a HV application such as e-mobility.

According to an embodiment, the sensor arrangement comprises at least two connecting elements, preferably exactly two connecting elements, for electrically connecting the sensor arrangement. The respective connecting element may comprise a terminal and a metallic wire. The respective connecting element protrudes from the outer housing for enabling an electrical connection of the sensor arrangement.

The respective connecting element, in particular the wire, may be at least partially covered by an insulating material. The wires of the connecting elements may be interwoven.

According to an embodiment, the mounting element is clamped to an outer surface of the outer housing. In this way, a quick and easy connection of the mounting element to the outer surface of the sensor arrangement is enabled.

According to an embodiment, a design of the mounting element is adaptable to a target application shape. In outer words, a shape of the mounting element may be adaptable to a desired location/target application at which the sensor arrangement is to be mounted. The mounting element may comprise a clip, a spring clip or a screw, for example. In this way, a very flexibly applicable sensor arrangement is provided.

According to a further embodiment, a use of a sensor arrangement is described. The sensor arrangement may be the previously described sensor arrangement. Thus, all features described in connection with the sensor arrangement apply for the use of the sensor arrangement and vice versa.

The sensor arrangement is used for measuring a surface temperature in a High Voltage target application, e.g. an e-mobility application. Preferably, the sensor arrangement is clipped to the target application.

Due to the introduction of the ceramic housing, the sensor arrangement can be produced with a glass NTC having full plastic overmoulded (double insulated) but keeping the fast response time and at the same time HV strength. The sensor arrangement comprises a very high HV resistance of up to 4300 V for DC. Additionally, the sensor arrangement comprises a very small size overall.

Furthermore, due to the introduction of the flexible mounting element (e.g. a spring clip) and the exposed ceramic housing surface, the sensor arrangement can measure the temperature from a bottom contact surface directly fast and fully insulated. Thus, the sensor arrangement provides a very fast response time.

### BRIEF DESCRIPTION OF THE DRAWINGS

Further features, refinements and expediencies become apparent from the following description of the exemplary embodiments in connection with the figures.

FIG. 1 schematically shows a perspective view of a sensor arrangement;

FIG. 2 schematically shows a perspective bottom view of the sensor arrangement according to FIG. 1;

FIG. 3 schematically shows a perspective side view of parts of the sensor arrangement according to FIG. 1;

FIG. 4 schematically shows a perspective view of parts of the sensor arrangement according to FIG. 1;

FIG. 5 schematically shows a sectional side view of the sensor arrangement mounted on a target application;

FIG. 6 schematically shows a sectional side view of the sensor arrangement;

FIG. 7 schematically shows a perspective view of the sensor arrangement; and

FIG. 8 schematically shows a sectional view of a part of the sensor arrangement.

In the figures, elements of the same structure and/or functionality may be referenced by the same reference numerals. It is to be understood that the embodiments shown in the figures are illustrative representations and are not necessarily drawn to scale.

### DETAILED DESCRIPTION OF ILLUSTRATIVE EMBODIMENTS

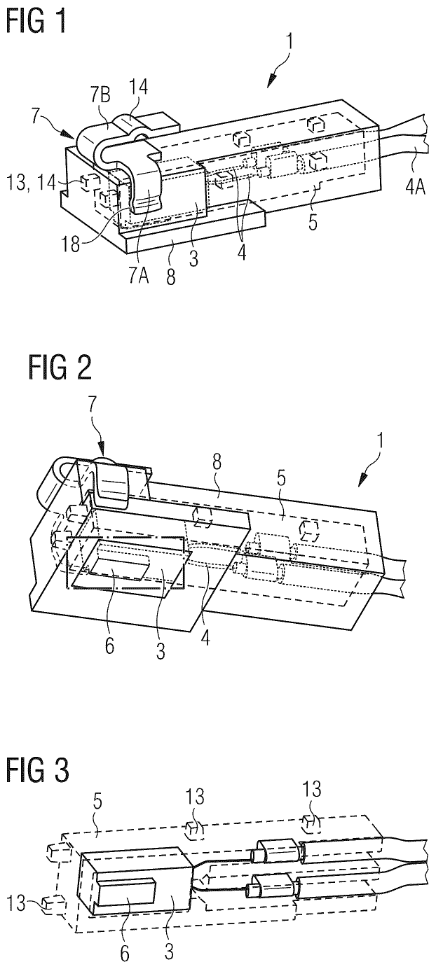

FIGS. 1 to 8 show a sensor arrangement 1 or parts thereof. The sensor arrangement 1 is a temperature sensor arrangement. In particular, the sensor arrangement 1 is configured for measuring a temperature of a surface, e.g. the temperature of a plastic surface.

The sensor arrangement 1 is adapted to be used in HV applications. It has a very high HV resistance as will be explained later on in detail. The HV resistance of the sensor arrangement is preferably 4300 V for DC.

The sensor arrangement 1 is specifically adapted to be used in automotive applications, in particular in e-mobility applications. For example, the sensor arrangement 1 can be used for temperature measurement on a bus bar surface for a HV application in the electro mobility sector. An operating temperature range of the sensor arrangement 1 is between −40° C. and 180° C., short term up to 200° C.

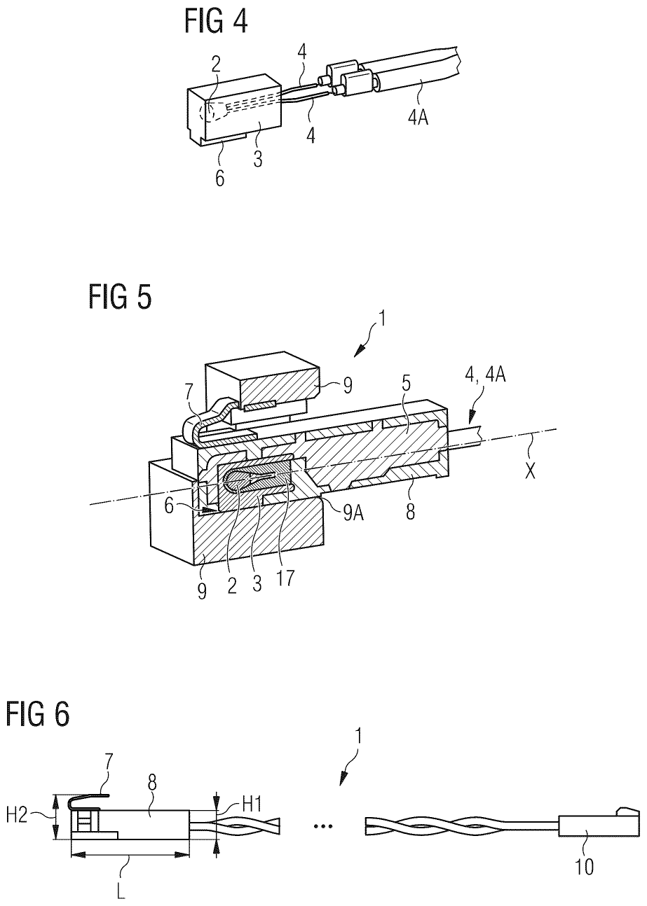

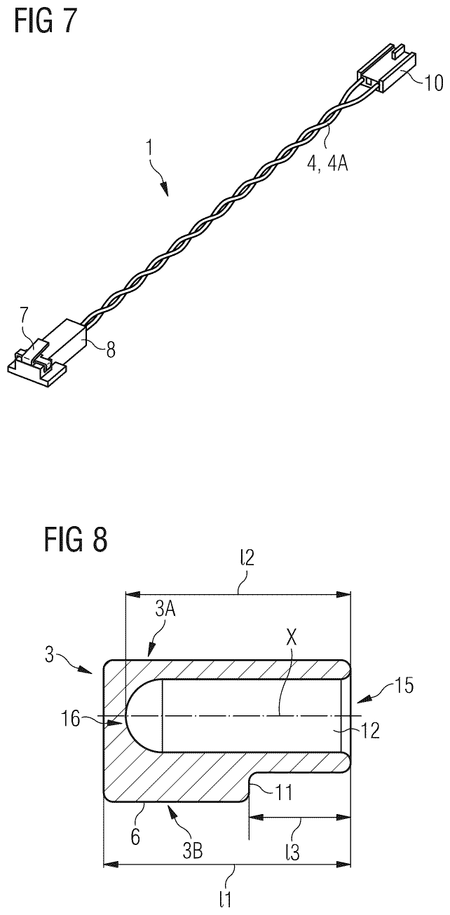

The sensor arrangement 1 comprises a sensor element 2 (see, in particular, FIG. 4). The sensor element 2 comprises an NTC thermistor, preferably a glass NTC thermistor. The sensor element 2 is connected with two connecting elements 4. The respective connecting element 4 may comprise a terminal and a metallic wire. The wires may be twisted together (see FIGS. 6 and 7). The wires are at least partially surrounded by an insulating material 4A.

The connecting elements 4 are adapted to electrically connect the sensor arrangement 1. In particular, the connecting elements 4 electrically connect the sensor arrangement 1 with a connector 10 as can be gathered from FIGS. 6 and 7. The connector 10 is adapted and arranged to electrically connect the sensor arrangement 1 with an external supply unit (not explicitly shown).

The sensor arrangement 1 further comprises a ceramic housing 3. The ceramic housing 3 comprises a top surface 3A, a bottom surface 3B and a hollow interior/hollow inner area 12 (FIG. 8). The bottom surface 3B may be that surface of the ceramic housing 3 that faces the surface the temperature of which is to be measured once the sensor arrangement 1 is mounted to a target application 9 (see in this context FIG. 5).

The ceramic housing 3 has an open end 15 and a closed end 16. In the inner area 12, the closed end 16 comprises a rounded shape. The sensor element 2 is arranged in the inner area 12 close to the rounded closed end 16 (see, for example, FIGS. 4 and 5). The sensor element 2 is firmly fixed in the inner area 12 of the ceramic housing 3 by means of a potting material 17 (FIG. 5). The connecting elements 4 partly protrude from the open end 15 of the ceramic housing 3 for enabling an electrical connection of the sensor arrangement 1 as described above (see FIG. 4).

The sensor arrangement 1 and, in particular, the ceramic housing 3 comprises a sensing area 6. The sensing area 6 is to be understood as an area of the ceramic housing 3 through which the surface temperature to be measured is transmitted directly to the sensor element 2. The sensing area 6 is arranged at the bottom surface 3B of the ceramic housing 3. The sensing area 6 is part of the bottom surface 3B.

The bottom surface 3B comprises an elevation. Thus, the bottom surface 3A is not smooth. In particular, the bottom surface 3A comprises an edge 11 (FIG. 8). In other words, the bottom surface 3A comprises two portions having different heights, i.e. extension perpendicular to a main longitudinal axis X of the ceramic housing 3/the sensor arrangement 1, with respect to one another. The sensing area 6 comprises that portion of the bottom surface 3B having a larger height as compared to the further/second portion of the bottom surface 3B. Expressed differently, the sensing area 6 is thicker than the remaining part of the bottom surface 3B so that it protrudes from the finished sensor arrangement 1.

The sensing area 6 is located directly beneath the sensor element 2 once the sensor element 2 is arranged within the ceramic housing 3. Furthermore, once the sensor arrangement 1 is mounted to the target application, the sensing area 6 rests directly on the surface 9A the temperature of which is to be measured (see FIG. 5). This will be explained later on in detail.

A total length l1 of the bottom surface 3A, and thus, of the ceramic housing 3, may be between 6 mm and 8 mm, for example 7.2 mm, 7.0 mm or 6.8 mm (FIG. 8). The term length in this context means the extension of the ceramic housing 3 along the main longitudinal axis X. A length l3 of that portion of the bottom surface 3A comprising the smaller height may be between 2 mm and 3 mm, for example 2.5 mm or 2.8 mm. A length l2 of the inner area 12 of the ceramic housing 3 may be between 6 and 7 mm, for example 6.5 mm or 6.2 mm.

The sensor arrangement 1 further comprises a basic body 5. The basic body 5 comprises plastic. The basic body constitutes a first HV insulation of the sensor arrangement 1. The basic body 5 is connected to the ceramic housing 3. In particular, the ceramic housing 3 is clamped into the basic body 5.

The basic body 5 partially surrounds the ceramic housing 3 and the connecting elements 4, as can be seen from FIGS. 1 to 3 and 5, for example. The connecting elements 4 protrude from a side surface of the basic body 5 to enable electrical connection of the sensor arrangement 1. Moreover, also the sensing area 6 (i.e. a part of the bottom surface 3A of the ceramic housing 3) is free from a material of the basic body 5.

The basic body 5 comprises a plurality of alignment features 13 arranged at an outer surface of the basic body 5. The alignment features 13 may comprise a protrusion, respectively. The alignment features 13 are adapted and arranged to align the basic body 5 with an outer housing 8 of the sensor arrangement.

The outer housing 8 of the sensor arrangement 1 constitutes a further/second HV insulation of the sensor arrangement 1. The outer housing 8 comprises plastic. A length L of the outer housing 8 may be between 20 mm and 25 mm, for example 22 mm or 23 mm (FIG. 6). Moreover, a height H1 of the outer housing 8 may be between 5 mm and 6 mm, for example 5.5 mm. A total height H2 of the sensor arrangement 1 including a later described mounting element 7 may be between 8 mm and 9 mm, for example 8.5 mm or 8.8 mm (FIG. 6).

The outer housing 8 at least partially envelops the basic body 5, the connecting elements 4 and the ceramic housing 3. The basic body 5, the ceramic housing 3 and the connecting elements 4 are at least partly overmoulded by a material of the outer housing 8. However, a portion of the bottom surface 3B of the ceramic housing 3, i.e. the sensing area 6, remains free from a material of the outer housing 8. In other words, the sensing area 6 is exposed.

In this way, the sensing area 6 can be placed directly onto the surface 9A when the sensor arrangement 1 is mounted to the target application 9A. Accordingly, no further component and, in particular, no insulating material, is arranged between the surface 9A and the sensing area 6. Thus, the sensor arrangement 1 has a very fast response time. In particular, the response time is t63<10 s (on surface).

Moreover, by means of the double insulation provided by the outer housing 8 and the basic body 5, the sensor arrangement 1 has a very high HV resistance. In particular, the HV resistance is 4300 V for DC.

Finally, the sensor arrangement 1 comprises a mounting element 7. The mounting element 7 comprises metal. The mounting element 7 is adapted and arranged for mounting the sensor arrangement 1 to the target application 9. In the embodiments shown, the mounting element 9 comprises a spring clip. However, different embodiments for the mounting element 7 are conceivable, e.g. a screw or a clip. In particular, a design of the mounting element 7 is adaptable to a target application shape.

In this embodiment, the mounting element 7 is clamped to an outer surface of the outer housing 8. For this purpose, the mounting element 7 comprises two resilient arms 7A having radial inward directed protrusions 18 which engage mating indentations of the outer housing 8 (FIGS. 1 and 2).

The mounting element 7 is further designed to be clipped to the target application 9. For this purpose, the mounting element 7 further comprises a spring arm 7B having a bulge 14. The spring arm 7B and, in particular the bulge 14, is adapted and arranged to mechanically cooperate with a mating structure of the target application 9, e.g. a cut-out, for firmly and easily connecting the sensor arrangement 1 to the target application 9.

Once the sensor arrangement 1 is mounted to the target application 9, the mounting element 7 and, in particular the spring arm 7B, provides a certain push down force towards a bottom, i.e. towards the surface 9A, where the measurement point is (FIG. 5). Furthermore, the mounting element 7 guarantees a mechanical strength at the mounting position in order to withstand vibrations required for a gear box, for example (highest acceleration may be 10.5 g).

In addition to that, once the sensor arrangement 1 is mounted to the target application 9, the sensing area 6 of the ceramic housing 3 is in direct mechanical contact with the surface 9A, the temperature of which is to be measured as can be gathered from FIG. 5. The exposed ceramic housing bottom surface 3B (i.e. the direct contact with the measurement point) guarantees a fast response time in addition to the HV strength.

The invention is not limited to the embodiments by the description based thereon. Rather, the invention encompasses any new feature as well as any combination of features, which in particular includes any combination of features in the claims, even if this feature or combination itself is not explicitly stated in the claims or embodiments.

1.-15. (canceled)

16. A sensor arrangement comprising:
at least one sensor element;
a ceramic housing, wherein the sensor element is at least partially arranged in the ceramic housing;
a basic body at least partially surrounding the ceramic housing;
an outer housing connected to the basic body, wherein the outer housing at least partially envelops the basic body and the ceramic housing; and
at least one mounting element configured for mounting the sensor arrangement to a target application,
wherein the ceramic housing is configured to be in direct mechanical contact with a surface, and
wherein the sensor arrangement is configured to measure a temperature of the surface.

17. The sensor arrangement according to claim 16,
wherein the ceramic housing comprises a sensing area, and
wherein the sensing area at least partially protrudes from the outer housing.

18. The sensor arrangement according to claim 17, wherein the outer housing completely surrounds the basic body and the ceramic housing except for the sensing area.

19. The sensor arrangement according to claim 16, wherein the sensor arrangement is at least partly overmoulded by a material of the outer housing.

20. The sensor arrangement according to claim 16, wherein the sensor element comprises a glass NTC thermistor.

21. The sensor arrangement according to claim 16, wherein the basic body and the outer housing constitute a double high voltage insulation of the sensor arrangement.

22. The sensor arrangement according to claim 16, wherein the basic body and the outer housing comprise plastic.

23. The sensor arrangement according to claim 16, further comprising:
at least two connecting elements configured for electrically connecting the sensor arrangement; and
an insulating material,
wherein the connecting elements are at least partially covered by the insulating material.

24. The sensor arrangement according to claim 16, wherein the mounting element is clamped to an outer surface of the outer housing.

25. The sensor arrangement according to claim 16, wherein the mounting element is adaptable to a target application shape.

26. The sensor arrangement according to claim 16, wherein the mounting element comprises a clip, a spring clip or a screw.

27. The sensor arrangement according to claim 16, wherein the sensor arrangement comprises a high voltage resistance≤4300 V DC.

28. A method of using the sensor arrangement according to claim 16, the method comprising: measuring the temperature in a high voltage target application.

29. The method according to according to claim 28, further comprising:
clipping the sensor arrangement to the target application.

30. The method according to claim 28, further comprising:
using the sensor arrangement in an e-mobility application.
